(19) United States
(12) Patent Application Publication
(10) Pub. No.: US 2019/0168528 A1
(43) Pub. Date: Jun. 6, 2019

(54) Calendar

(71) Applicant: Helen PARK, Los Angeles, CA (US)

(72) Inventor: Helen PARK, Los Angeles, CA (US)

(21) Appl. No.: 16/212,222

(22) Filed: Dec. 6, 2018

Related U.S. Application Data
(60) Provisional application No. 62/595,486, filed on Dec. 6, 2017.

(51) Int. Cl. B42D 1/00; B42D 1/06

(52) U.S. Cl. CPC B42D 1/004; B42P 2241/12; B42P 2241/10; B42D 1/06

(57) ABSTRACT

A calendar comprises a planar frame, one or more ring sections, and an insert section. The planar frame of a first dimension has an inner surface portion and an outer surface portion and configured to be folded along a central portion on both directions. The one or more ring sections are installed along the central portion of the planar frame. The insert section has a second dimension and attached to the planar frame through the one or more ring sections on the inner surface portion of the planar frame, so as to be enclosed by the planar frame or disposed on a surface of the planar frame. The first dimension is larger than the second dimension so that the planar frame encloses the insert section with specific margins around one or more edges of the insert section. Both ends of the planar frame are configured to be connected.

### RELATED APPLICATION

This application is a Non-provisional application of Provisional Application Ser. No. 62/595,486 for “Calendar” filed on Dec. 6, 2017.

### BACKGROUND OF THE INVENTION

The present invention relates to a calendar.

Many types of calendars are available, but always there are some points to improve in the conventional calendars.

Calendars are used globally even in the digital information age or the era of information revolution.

Conventional calendars are available to be used on walls as well as desks. In such cases, the calendars may be specific structures, but always there is something to improve for convenience.

Accordingly, a need for a calendar has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a calendar.

An aspect of the invention provides a calendar, which comprises a planar frame, one or more ring sections, and an insert section.

The planar frame of a first dimension has an inner surface portion and an outer surface portion and configured to be folded along a central portion on both directions.

The one or more ring sections are installed along the central portion of the planar frame.

The insert section has a second dimension and attached to the planar frame through the one or more ring sections on the inner surface portion of the planar frame, so as to be enclosed by the planar frame or disposed on a surface of the planar frame.

The first dimension is larger than the second dimension so that the planar frame encloses the insert section with specific margins around one or more edges of the insert section.

Each of the planar frame and the insert section may have a rectangular shape.

Horizontal margins between horizontal edges of the planar frame and the insert section may be same as vertical margins between vertical edges of the planar frame and the insert section.

Alternatively, the horizontal margins between horizontal edges of the planar frame and the insert section may be different from vertical margins between vertical edges of the planar frame and the insert section.

The planar frame may comprise a first hole, a cover portion, and a back portion.

The first hole is provided on an edge portion of the planar frame and configured to hang the calendar to a wall surface.

The cover portion is configured to cover a front side of the insert section. The back portion is configured to cover a rear side of the insert section.

The insert section may comprise one or more pages and second holes.

The one or more pages are for printing information on surfaces thereof.

The second holes are provided through the one or more pages, which correspond and are aligned to the first hole of the planar frame.

The one or more pages may comprise a calendar, and the one or more pages are configured to identify days and dates daily, weekly, monthly, or annually.

The first and second holes may be configured to hang the calendar on an external nail.

The one or more ring sections may be integrated into one long ring section.

The cover portion may comprise a first folding line and the back portion comprises a second folding line, and a first edge of the cover portion is connected to a second edge of the back portion, forming a third folding line, so that the planar frame is formed in a shape of triangular prism.

The third folding line may comprise one or more connecting rings. Each of the one or more connecting rings may be detachable.

The advantages of the present invention are: (1) the calendar according to the present invention is easy and convenient to use; (2) the calendar according to the invention can be used on walls as well as on desks; and (3) the calendar according to the present invention has a simple structure so as to be manufactured easily.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view showing a calendar that is closed according to an embodiment;

FIG. 2 is a perspective view showing a calendar that opens at the first page according to an embodiment;

FIG. 3 is another perspective view showing a calendar that opens in the middle of pages according to an embodiment;

FIG. 4 is still another perspective view showing a calendar that opens in the middle of pages according to an embodiment;

FIG. 5 is a perspective view showing a calendar that opens at the last page according to an embodiment;

FIG. 6 is a perspective view showing a top portion of a calendar that opens in the middle according to an embodiment of the present invention;

FIG. 7 is a perspective view showing a calendar for desk according still another embodiment;

FIG. 8 is another perspective view showing the calendar of FIG. 7;

FIG. 9 is a side plan view showing a calendar for desk according still another embodiment; and

FIG. 10 is a partial view showing connecting two edges of a cover portion and a back portion according to still another embodiment.

### DETAILED DESCRIPTION EMBODIMENTS OF THE INVENTION

The U.S. Provisional Patent Application No. 62/595,486 for “Calendar” filed on Dec. 6, 2017 is incorporated by reference herein for any and all purposes.

Referring to the figures, the embodiments of the invention are described in detail.

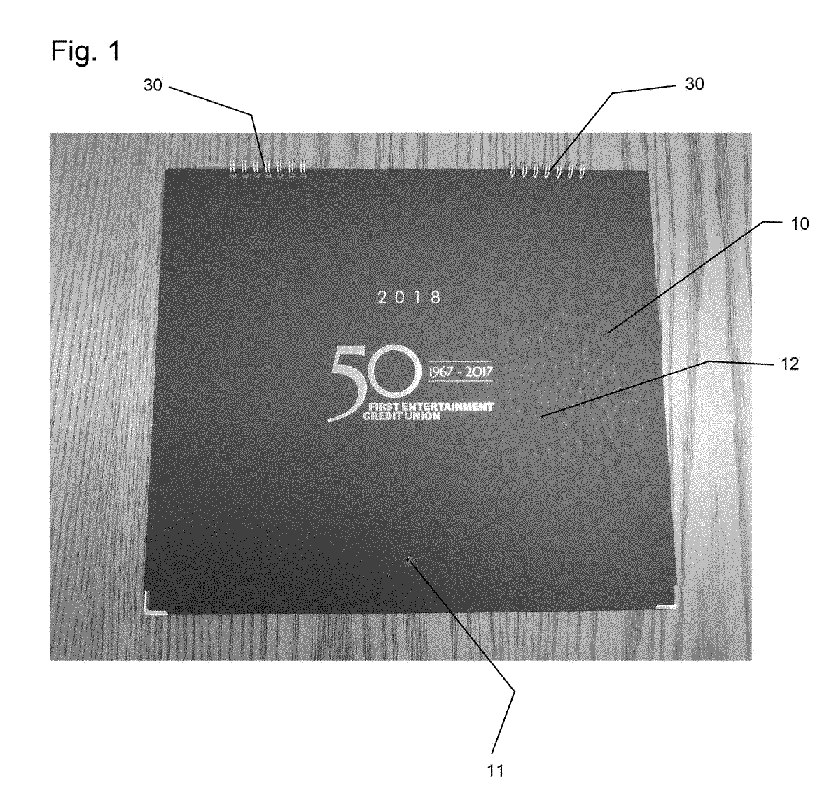

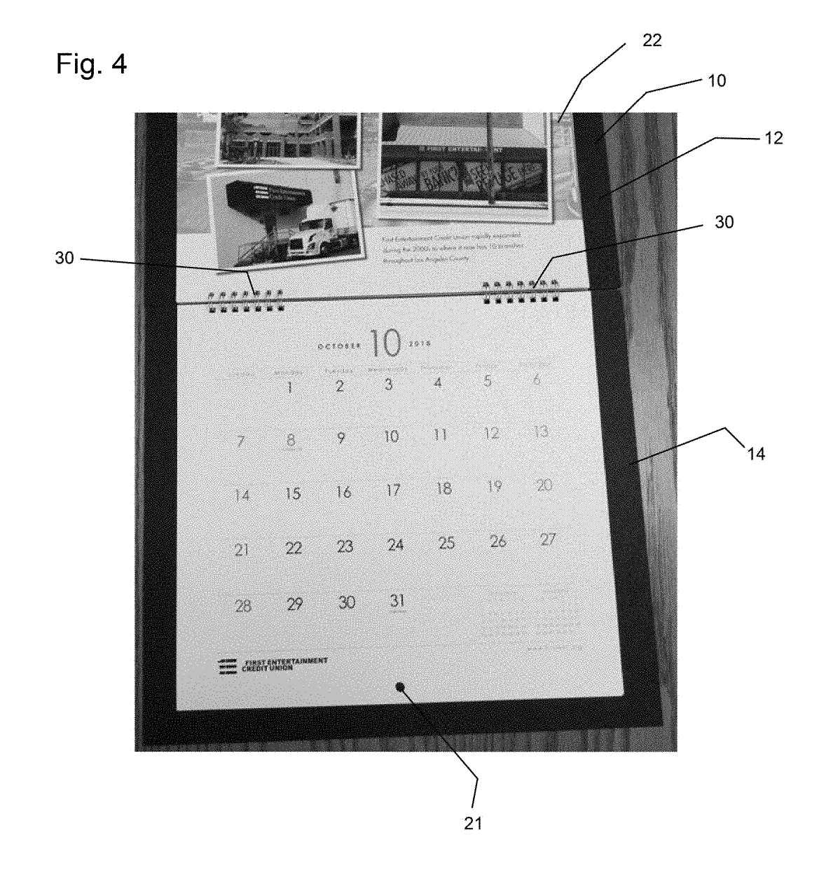

The invention is a calendar with a frame (10) around an insert section (20) as shown in FIGS. 1 through 6.

The insert section (20) contains a plurality of pages (22) for identifying the days and the dates—weekly, monthly, or even annually.

The frame (10) is larger than the insert section (20), such that when the calendar opens up the frame (10) surrounds the insert section (20) as shown in FIGS. 1, 2, and 5.

The hole (21) on the upper portion of the insert section (20) corresponds with a hole (11) in the frame (10) for hanging.

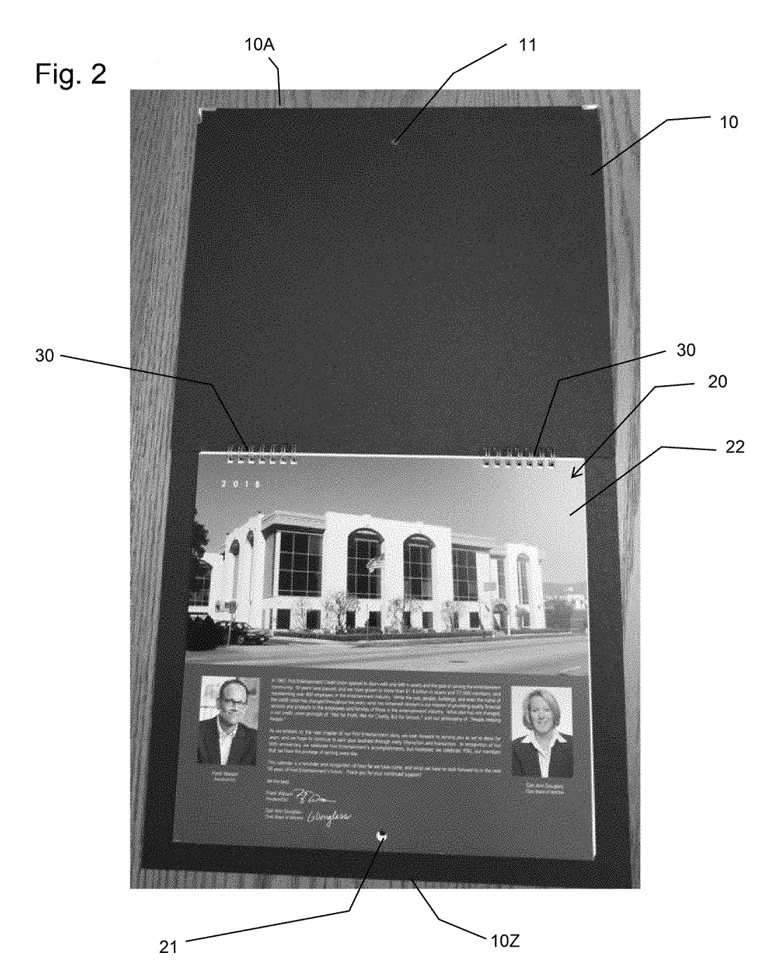

The frame (10) comprises of a cover (12) and a back (14), so when the cover (12) opens up, the insert section (20) of the calendar appears to have a frame (10) around the calendar insert section (20) as shown in FIGS. 2 through 5.

The frame (10) and the insert section (20) may have one or more ring sections (30) for easy opening of the cover (12) and one or more pages (22) of the insert section (20).

In FIG. 1, the frame (10) may be rectangular, and the one or more ring section (30) may be provided integrally as one continuous one all the way along the top edge portions of the cover (12) and the back (14).

In FIG. 2, the cover (12) and the back (14) may be connected along the top folded edge of the frame (10) as illustrated.

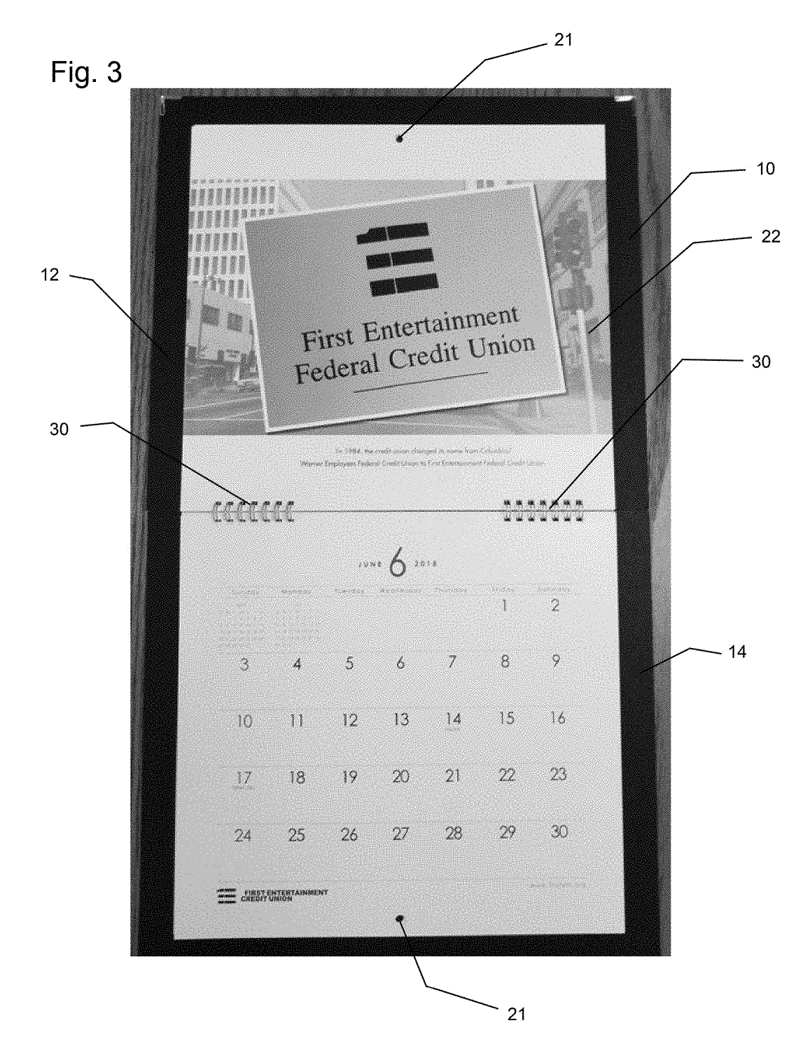

In FIG. 3, the frame (10) is large enough to extend beyond the edge of the plurality of pages (22) in the insert section (20), so that when the frame (10) is folded the plurality of pages (22) are not exposed outside as shown in FIGS. 1, 4, and 5.

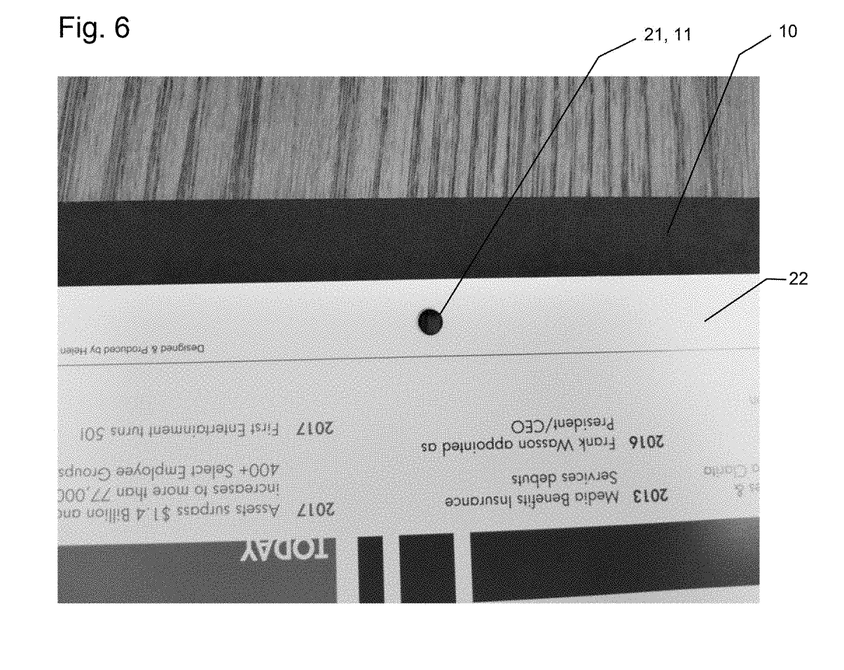

In FIG. 6, the holes (11, 21) are configured to overlap with each other. And the shape of the holes (11, 21) is circular, but not limited to it. In certain embodiment, the holes (11, 21) may be oval.

In certain embodiments of the present invention, the frame (10) may be made of relatively solid sheet, and the calendar may be provided on the plurality of pages (22).

As shown in FIGS. 1-10, an aspect of the invention provides a calendar, which comprises a planar frame (10), one or more ring sections (30), and an insert section (20).

The planar frame (10) of a first dimension has an inner surface portion and an outer surface portion and configured to be folded along a central portion on both directions as shown in FIGS. 1 and 2.

The one or more ring sections (30) are installed along the central portion of the planar frame (10). The ring sections (30) may be made of plastic or metal.

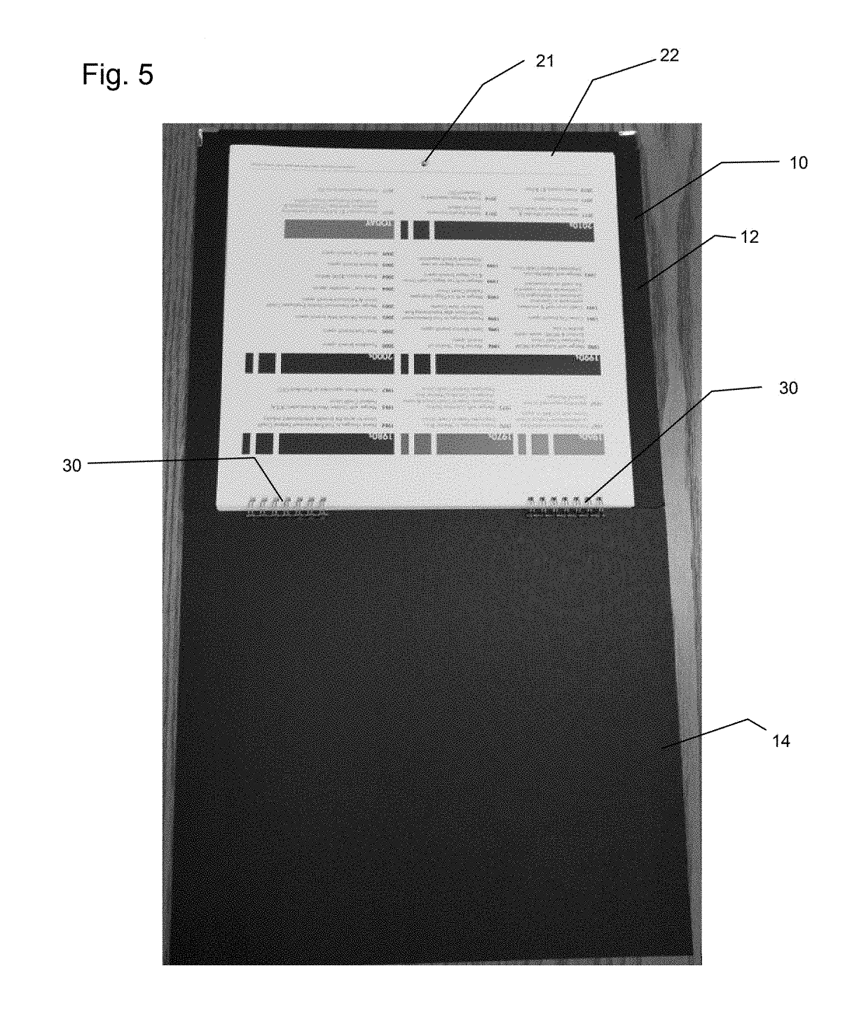

The insert section (20) has a second dimension and attached to the planar frame (10) through the one or more ring sections (30) on the inner surface portion of the planar frame (10), so as to be enclosed by the planar frame (10) or disposed on a surface of the planar frame (10) as shown in FIGS. 3 and 5.

The first dimension is larger than the second dimension so that the planar frame (10) encloses the insert section (20) with specific margins around one or more edges of the insert section (20) as shown in FIGS. 2 through 5.

Each of the planar frame (10) and the insert section (20) may have a rectangular shape, but not limited to it. For example, the planar frame (10) may have a shape of triangle, pentagon, hexagon, are other polygons.

Horizontal margins (the black portion in FIG. 6) between horizontal edges of the planar frame (10) and the insert section (20) may be same as vertical margins between vertical edges of the planar frame (10) and the insert section (20) as shown in FIG. 3.

Alternatively, the horizontal margins between horizontal edges of the planar frame (10) and the insert section (20) may be different from vertical margins between vertical edges of the planar frame (10) and the insert section (20) as shown in FIG. 5.

The planar frame (10) may comprise a first hole (11), a cover portion (12), and a back portion (14).

The first hole (11) is provided on an edge portion of the planar frame (10) and configured to hang the calendar to a wall surface.

The cover portion (12) is configured to cover a front side of the insert section (20). The back portion (14) is configured to cover a rear side of the insert section (20).

The insert section (20) may comprise one or more pages and second holes (21) as shown in FIG. 5.

The one or more pages are for printing information on surfaces thereof.

The second holes (21) are provided through the one or more pages, which correspond and are aligned to the first hole (11) of the planar frame (10) as shown in FIG. 6.

The one or more pages may comprise a calendar, and the one or more pages are configured to identify days and dates daily, weekly, monthly, or annually.

The first and second holes (11, 21) may be configured to hang the calendar on an external nail (not shown).

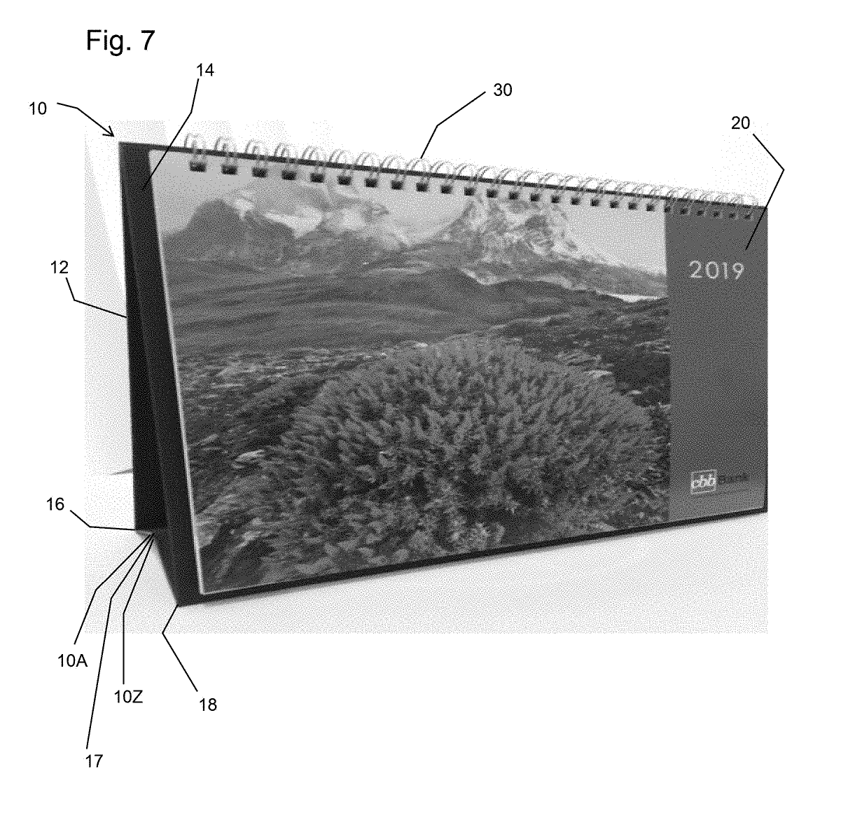

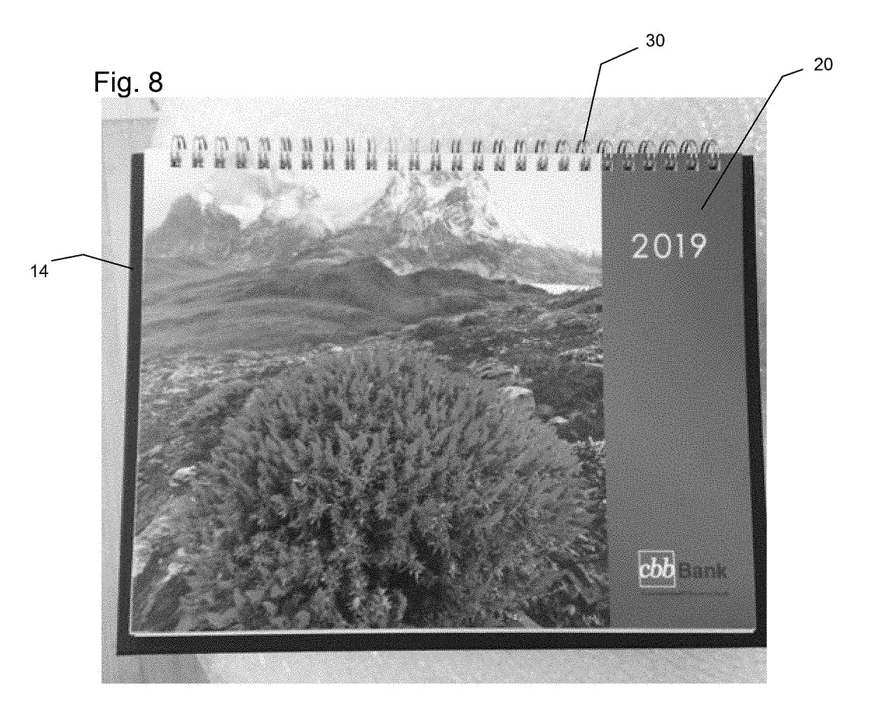

The one or more ring sections (30) may be integrated into one long ring section as shown in FIGS. 7 and 8.

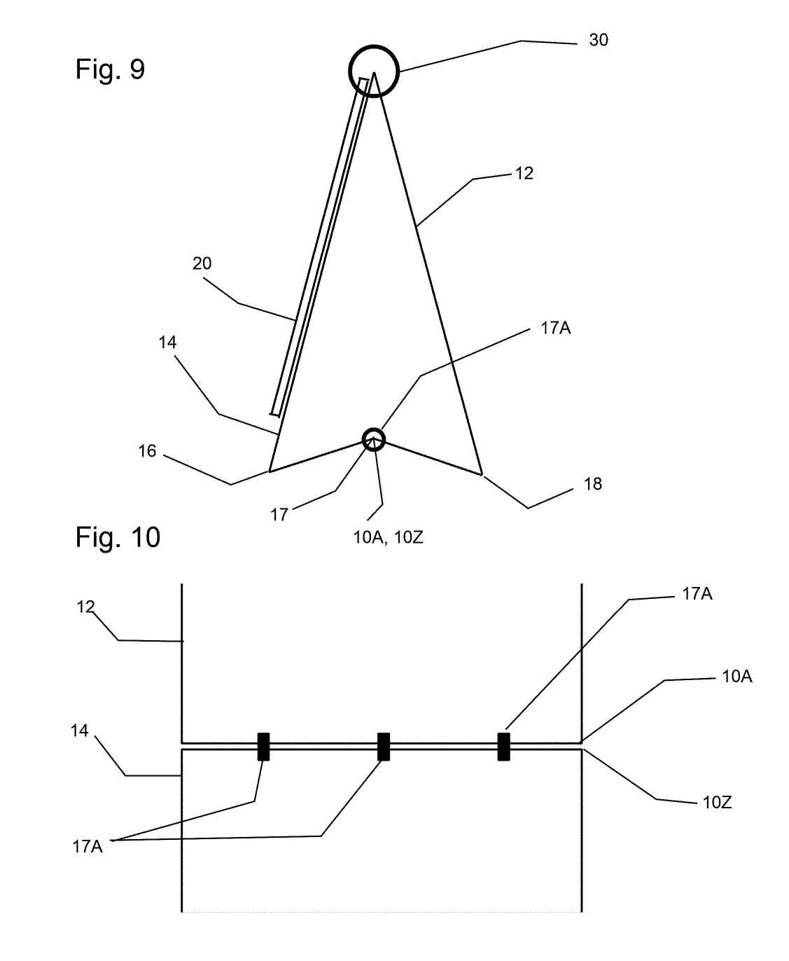

The cover portion (12) may comprise a first folding line (16) and the back portion (14) comprises a second folding line (18), and a first edge (10A) of the cover portion (12) is connected to a second edge (10Z) of the back portion (14), forming a third folding line (17), so that the planar frame (10) is formed in a shape of triangular prism as shown in FIGS. 7 and 9.

The third folding line (17) may comprise one or more connecting rings (17A) as shown in FIGS. 9 and 10. Each of the one or more connecting rings (17A) may be detachable.

The planar frame (10) may be made of paper or cardboard or any other sheet material.

The one or more ring sections (30) may be made of plastic or metal springs.

The one or more connecting rings (17A) may be made of plastic or metal clips. The plastic or metal clip may be circular.

The inner surface of the planar frame (10) may have a color different from a color of the insert section (20), so that the margins of the planar frame (10) surrounding the insert section (20) look as if it is presented in a plaque.

The calendar may be used on walls as well as desks as shown in FIGS. 3 and 7.

The first and second folding lines (16, 18) are provided by folding, perforating, and other well-known methods. They can be made to be folded either way.

The third folding line (17) may be formed naturally by a gap between the edges (10A, 10Z).

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A calendar comprising:
a planar frame of a first dimension having an inner surface portion and an outer surface portion and configured to be folded along a central portion on both directions;
one or more ring sections installed along the central portion of the planar frame; and
an insert section having a second dimension and attached to the planar frame through the one or more ring sections on the inner surface portion of the planar frame, so as to be enclosed by the planar frame or disposed on a surface of the planar frame,
wherein the first dimension is larger than the second dimension so that the planar frame encloses the insert section with specific margins around one or more edges of the insert section.

2. The calendar of claim 1, wherein each of the planar frame and the insert section has a rectangular shape.

3. The calendar of claim 2, wherein horizontal margins between horizontal edges of the planar frame and the insert section are same as vertical margins between vertical edges of the planar frame and the insert section.

4. The calendar of claim 2, wherein horizontal margins between horizontal edges of the planar frame and the insert section are different from vertical margins between vertical edges of the planar frame and the insert section.

5. The calendar of claim 2, wherein the planar frame comprises:
a first hole provided on an edge portion of the planar frame and configured to hang the calendar to a wall surface;
a cover portion configured to cover a front side of the insert section; and
a back portion configured to cover a rear side of the insert section.

6. The calendar of claim 5, wherein the insert section comprises:
one or more pages for printing information on surfaces thereof; and
second holes provided through the one or more pages, which correspond and are aligned to the first hole of the planar frame.

7. The calendar of claim 6, wherein the one or more pages comprise a calendar, and the one or more pages are configured to identify days and dates daily, weekly, monthly, or annually.

8. The calendar of claim 6, wherein the first and second holes are configured to hang the calendar on an external nail.

9. The calendar of claim 1, wherein the one or more ring sections are integrated into one long ring section.

10. The calendar of claim 5, wherein the cover portion comprises a first folding line and the back portion comprises a second folding line, and a first edge of the cover portion is connected to a second edge of the back portion, forming a third folding line, so that the planar frame is formed in a shape of triangular prism.

11. The calendar of claim 10, wherein the third folding line comprises one or more connecting rings.

12. The calendar of claim 12, wherein each of the one or more connecting rings is detachable.
